(19) United States
(12) Patent Application Publication
(10) Pub. No.: US 2009/0297036 A1
(43) Pub. Date: Dec. 3, 2009

(54) OBJECT DETECTION ON A PIXEL PLANE IN A DIGITAL IMAGE SEQUENCE

(75) Inventors: Hernan Badino, Maichingen-Sindelfingen (DE); Uwe Franke, Uhingen (DE); Stefan Gehrig, Altdorf (DE); Clemens Rabe, Boeblingen (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 11/993,398

(22) PCT Filed: Jan. 3, 2006
(86) PCT No.: PCT/EP06/00013

§ 371 Date: Jan. 23, 2009

(30) Foreign Application Priority Data
Jan. 31, 2005 (DE) 10 2005 004 510.3
Feb. 21, 2005 (DE) 10 2005 008 131.2

(51) Int. Cl. G06K 9/62

(52) U.S. Cl. 382/209

(57) ABSTRACT

The invention relates to a method for detecting objects on a pixel plane. Said movable object detection is frequently possible only by tracking the pre-segmented objects or the parts thereof. in this relation, the spatially adjacent objects often provoke problems, in particular in the case when a camera system or more precisely an observer is movable. The inventive method consists in determining a two-dimensional position of the relevant pixels inside a first image and in determining an associated remote value for each relevant pixel. Said pixels are tracked and localized on two ore more successive images, wherein the two-dimensional position or the pixel offset and the associated remote value are again determined for each pixel. The position and movement of the relevant pixels are also determined with the aid of a suitable filter. Finally, the relevant pixels are combined into objects under predefined conditions with respect to the position, moving direction and motion ratio thereof.

The invention concerns a process for object detection on pixel planes in digital image sequences.

High-powered devices in the field of video and computer technology allow the employment of digital image processing in almost all scientific areas and engineering disciplines. Therein the set task is often the recognition of objects. In object detection, conventionally, in a first step, objects of interest are separated from background objects. For this, characteristics are segmented out of images using image processing techniques. Subsequently, the segmented characteristics are recognized in a following step using classification processes and expressly assigned to an object class. The detection of moving objects is frequently possible by tracking previously segmented objects or object parts. In these cases, the capability of a process for detection of rapidly moving objects depends essentially upon the quality of the segmenting. Frequently however problems occur in association with the segmentation, particularly in the case of especially closely adjacent objects. Object recognition is employed with great success, for example, in quality control for industrial purposes. Similarly, object recognition by means of digital image processing is also suitable for employment for environment detection in vehicles or other mobile systems.

From the state of the art, processes for stereo image analysis are known. Therein, by analysis of an image pair from a calibrated stereo camera apparatus, pixels relevant to the 3D-position are determined. For example, a process of this type for stereo image analysis is described in “Real-time Stereo Vision for Urban Traffic Scene Understanding, U. Franke, IEEE Conference on Intelligent Vehicles 2000, October 2000, Dearborn,” wherein pixels are first determined by means of an interest operator, of which the stereo disparity can be easily measured. Subsequently then a hierarchical correlation process is employed in order to measure the disparity and therewith to determine the 3D-position of relevant pixels. With an image analysis process of this type objects can be discriminated from background, in that adjacent pixels with the same distance to the image sensor are merged into an object. It is also known to improve the precision of 3D-measurements by means of a stereo image analysis, in that the pixels being examined are tracked over time. One process for tracking pixels in image scenes is known for example from “Dynamic Stereo with Self-Calibration, A. Tirumalai, B. G., Schunk, R. C. Jain, IEEE Trans. on Pattern Analysis and Machine Intelligence, Vol. 14 No. 12, December 1992, pp. 1184-1189,” wherein, following a special initialization phase, the position of static pixels are determined with increased precision.

According to the state of the art further processes for image supported object detection are known, in which information essentially flows in via or regarding the 3D-Position, where after an initial segmenting potential objects are further processed in the form of an entity and their movement parameter is determined using a Kalman-filter. For example in U.S. Pat. No. 6,677,941B2 a system for three dimensional relative tracking and positioning in association with unmanned micro space transporters for docking to satellite modules are disclosed. Herein a laser image sensor is used for detecting environment information in the form of distance values and gray values. The detected environment information are then evaluated using image processing processes such as for example correlation processes, sub-pixel tracking, focal length determination, Kalman-filtering and determination of orientation, in order therewith to determine the relative 3D-position and orientation of a target object. Since a target object can be described by multiple marks or points of interest, it is sufficient herein to track an object by a marker or point of interest describing the object. Therewith it is possible even in the case of large target objects that these are reliably detected with only one sensor.

The invention is concerned with the task of providing a new process for object detection on an pixel plane in digital image sequences.

The task is solved in accordance with the invention by a process having the characteristics of Patent claim 1. Advantageous embodiments and further developments are set forth in the dependent claims.

According to the invention a process for object detection on an pixel plane in digital image sequences is proposed. In the process, in an inventive manner, within a first recorded image the 2D-position of relevant pixels is determined, and for each relevant pixel an associated distance value is determined. These pixels are tracked and localized in at least a second recorded image, and a renewed determination of the 2D-position or the displacement of the pixel, as well as the associated distance value, is determined. Additionally by means of at least one suitable filter the position and movement of relevant pixels are determined. Finally, under predetermined conditions, relevant pixels are then merged into objects. The inventive process provides, on the basis of the fusion of spatial and time information for each considered pixel, a precise 3D-position as well as the associated 3D direction of movement, whereby the processing complexity can be significantly simplified in comparison to the segmenting process known from the state of the art which necessitates a complex preprocessing, so that a rapid and robust detection of moving objects is made possible even in the case of complicated geometric constellations. Therein no supplemental evaluation steps liable to introduce errors are necessary, such as, for example, classifiers. With the inventive process the essential advantage is achieved that therewith, in a very simple manner, stationary contents of the image on the pixel plane and moving contents of the image on the pixel plane can be separated from each other. In particular, a targeted search can be made for pixel groups and objects with particular direction of movement and speeds on the basis of the pixel plane. Thereby even closely adjacent objects can be readily distinguished from each other, in particular also on the image side edges, where generally due to own movement even directly sequential recorded images can have strong changes in the image contents. For example, a pedestrian or bicyclist moving in front of a stationary object, e.g., in front of a wall of a house, can be detected with the inventive process in a reliable manner and be distinguished therefrom. In contrast, the processes known from the state of the art and based purely upon a stereo projection process cannot distinguish these from each other, at least in the case of greater distances.

In association with the invention the term “relevant pixels” is understood to mean those pixels which are suitable for tracking in at least two or more sequential image recordings of an image sequence, for example by exhibiting a particular contrast. For selection of relevant pixels there is suited for example a process described in “Detection and Tracking of Point Features, School of Computer Science, Carnegie Mellon University, Pittsburg, Pa., April 1991 (CMU-CS-91-132).” For these relevant pixels a 3D-position determination is carried out, thus it is further of advantage, in the case that on the basis of these relevant pixels a stereo disparity can also be easily determined. After the determination of the 3D-position relevant pixels are subsequently tracked and localized in the subsequent image. Therein it is not absolutely essential that the image recording is directly subsequent to the first image recording. The “KLT-Tracker” described in the above-referenced is an example of a suitable tracking program. With a renewed stereoscopic 3D-position determination the cycle closes, whereupon the process can continue in the same manner.

In a particularly advantageous embodiment of the invention the own movement of the image sensor is taken into consideration during the determination of position- and movement-relevant pixels. Thereby it is possible, even in the case of a moving image sensor, to reliably detect objects. The objects to be detected can in this case be stationary as well as moving objects. The positions and movements of relevant pixels detected in a framework of object detection can therein be with reference to locationally fixed coordinates, or however also based on moving coordinate system of a movable image sensor, which is located for example on a motor vehicle.

In a preferred embodiment the own movement of the image sensor is determined on the basis of image recordings and/or by means of an internal sensor system. For example, an internal sensor system is incorporated in modem motor vehicles, which detect the movement, tilt, acceleration and RPM, etc. The measured values describing the own movement of the vehicle and therewith also those of a vehicle associated image sensor are provided for example via the vehicle bus system. In contrast thereto In the determination of the own movement of the image sensor on the basis of image recordings there are pixels tracked and checked in image recordings of sufficient length, as to whether this is at rest and thus does not move. On the basis of selected immobile pixels, and using a suitable image evaluation processes, the own movement of the motor vehicle or, as the case may be, the image sensor, can be determined. A suitable process of this type for determining the own movement is disclosed for example in “A. Mallet, S. Lacroix, L. Gallo, Position estimation in outdoor environments using pixel tracking and stereovision, Proc. IEEE Int. Conference on Robotics and Automation, Vol. 4, pp. 3519-3524, 24-28, Apr, 2000.”

In a further advantageous embodiment of the invention the at least one filter for determining position and movement of relevant pixels is a Kalman-Filter. In the inventive process, for each relevant tracked pixel a Kalman-Filter is associated with a condition vector [x y z vx vy vz]. The values x, y, and z describe therein the spatial position of the pixel, for example in a coordinate system fixed to and moving along with the motor vehicle. The values of vx, vy and vz characterize therein the speed in the respective spatial direction. Although only the spatial position describing inputs x, y and z of the condition vector are directly measurable, it is possible with the Kalman-Filter, using model assumptions, to determine all six values of the condition vector (state vector). Therewith, using a Kalman-Filter, relevant pixels can be tracked in reliable manner on the basis of two or more image recordings, and their spatial position as well as their direction of movement and speed of movement can be determined. Expressed with different words, by means of the Kalman-Filter the spatial and time information is integrated, whereby a reliable detection of rapidly moving objects is for the first time made possible. In the dissertation “Detection of Impediments in front of Vehicles by Movement Analysis, C. Rabe, Technical College Wuerzburg-Schweinfurt, Department of Information Technology and Information Management, February 2000” mathematical calculations required for vehicle environment analysis in association with the Kalman-Filter based multi-filter system are described in detail.

It has been found particularly advantageous in association with the inventive process that each relevant pixel is not subjected to only one filter but rather to multiple filters in the determination of its position and movement. In the case that multiple filters are utilized for determining position and movement of relevant pixels, then in an advantageous manner either different movement models or a movement model with different initializations and/or parameterization is used as underlying basis. The initialization of the filter differs preferably with respect to the direction of movement and the magnitude of the speed, for example, the filter can proceed from the hypothesis that the relevant pixel to be considered is at rest and does not move. A further filter can at the same time begin with the assumption of a moving pixel. Herein further assumptions can be met, in particular in the context of the respective applications. For example, in association with a motor vehicle application a filter can begin with the hypothesis that the pixel to be observed represents a part of a vehicle approaching with high relative speed whereas a further filter can begin with the hypothesis that the pixel is an pixel associated with a vehicle preceding the own vehicle with a similar speed. Taking in to consideration the initiation errors of the individual filters it can already be decided after only a few image cycles whether a hypothesis is applicable or not.

It is further of great advantage when the results from the individual filters are merged or integrated into a combined result. For example, different filters can be merged thereby, in that the individual results are merged as weighted average values into an overall result. Therewith one obtains much more quickly, in contrast to a single filter system, a convergence between estimated values and the actual value which is of particularly great advantage in particular in real-time applications such as, for example, collision avoidance. Therein there exists the possibility that the total result of the filtering in a further advantageous manner are back-coupled to the inputs of the individual filters. The overall result is influenced herein in particular by the parameter adjustment or setting of the individual filters and thus acts in advantageous manner on the future determination of position and movement of relevant pixels.

The distance values associated with a pixel are in advantageous manner determined by image recordings and/or by means of distance resolving sensor systems. For example the distance associated with one pixel can be determined by means of a process for stereo image analysis. Therein, by analysis of an image pair, a calibrated stereo camera arrangement can determine the 3D-position of relevant pixels. Alternatively or in addition there is, however, the possibility that the distance values associated with an pixel are determined by means of a suitable distance resolving sensor. This could be for example a supplemental narrow beam laser sensor, which provides direct distance values to a particular object point. Also known from the state of the art are for example laser scanners or distance imaging cameras which provide a depth value for each pixel.

In association with the invention preferably those pixels which exhibit similar condition vectors are merged into objects, wherein for example gates are provided for the maximum permissible deviation of individual or multiple elements of the condition vector. In an advantageous manner only those relevant pixels which satisfy pre-determined conditions with respect to their position and/or movement, and/or exhibit a specified minimum age, are merged into objects. For example, the object detection can be limited to only certain image areas, for example, in association with vehicle applications the object detection can be limited to specified vehicle lanes. Therein it is further conceivable that only those relevant pixels are to be merged into objects which exhibit a specified direction of movement. There is for example the possibility that in an application in which vehicles merging into or out of the own lane are to be displayed to the driver only those pixels are to be merged or combined into objects which taking into consideration specified tolerances exhibit a diagonal direction of movement. It is further conceivable that only such pixels are to be combined into objects which exhibit a specified minimum age. For example, a minimum age of five image cycles could be required in order therewith to exclude those pixels from the object detection which, due to noise, exhibit particular characteristics with respect to their position and movement. In the framework of the assimilation of relevant pixels into objects there exists also the possibility that any possible combination of the above-mentioned criteria can be drawn upon.

It is also a great advantage in the case that already correlated objects are further tracked in picture recordings or image recordings by means of filters. Processes which, after an initial segmenting, further track the 3D-position of potential objects as entities are already known from the state of the art and are based for example on simple Kalman-Filters. This tracking of already correlated pixels into objects is also used in correlation with the inventive process. Therewith, on the one hand, very reliable segmentation can be generated and, on the other hand, very good initial estimations of object movements can be carried out. In an advantageous manner, for initialization of the filtering, the position and movement, in particular the condition vectors of merged pixels, are used. In contrast, for tracking of objects, preferably the continuously determined position and movement of individual pixels are used.

The inventive process for object detection on the pixel plane can be employed for example in association with driver assist systems. Diverse applications for driver assist systems are already known, which are based on an image-supported object detection. For example, systems for traffic sign recognition, for parking assist, for lane tracking, etc. are known. Since the inventive process is characterized by its speed and robustness with respect to the results detected, it presents itself above all for association with employment for collision recognition or, as the case may be, collision avoidance. The driver can be alerted thereby in advance with respect to suddenly approaching traffic participants, or the system can for example actively engage in the vehicle dynamics.

The inventive process for object detection on the pixel plane can also be employed in association with robot systems. Future robots will be equipped with image providing sensors. These could be, for example, autonomous transport systems which freely navigate in their environment of use, or could involve stationary robots. The inventive process can be employed in this context for example for collision recognition or for collision avoidance. It is however also conceivable that the process is employed in association with a robot for secure gripping of moveable objects. The moveable objects could be, for example, moving work-pieces or a human which the robot is assisting.

1. A process for object detection on an pixel plane in digital image sequences comprising
determining in a first image recording the 2D-position of relevant pixels,
determining for each relevant pixel an associated distance value,
tracking and localizing these pixels in at least a second image recording,
wherein for each of the pixels the 2D-position or the displacement of the pixel as well as the associated distance value is determined anew,
wherein by means of at least one suitable filtering the 3D-position and 3D-movement of relevant pixels is determined, and
wherein under predetermined conditions relevant pixels are assimilated into objects,
wherein in the case that multiple filters are used in the filtering for determination of 3D-position and 3D-movement of relevant pixels, either different movement models or a movement model with different initializations and/or parameter settings is used as basis.

2. The process for object detection according to claim 1, wherein the result of the individual filters is merged into a cumulative product of the filtering.

3. The process for object detection according to claim 2, wherein the overall result of filtering is back coupled to the input of the individual filters.

4. The process for object detection according to claim 1, wherein at least one filter for identification of position and movement of relevant pixels is a Kalman-Filter.

5. The process for object detection according to claim 1, wherein the own movement of the image sensor is taken into consideration during the determination of position and movement of relevant pixels.

6. The process for object detection according to claim 5, wherein the own movement of the image sensor is determined on the basis of image recording and/or by means of an internal sensor system.

7. The process for object detection according to claim 1, wherein the distance value associated with one pixel is determined on the basis of image recordings and/or by means of distance resolving sensors.

8. The process for object detection according to claim 1, wherein only those relevant pixels which satisfy predetermined conditions with respect to their position and movement and/or have a specified minimum age are assimilated into objects.

9. The process for object detection according to claim 1, wherein assimilated objects continue to be tracked in image recordings by means of filters, wherein, for initialization of filtering, the positions and movement of assimilated pixels are employed.

10. The process for object detection according to claim 9, wherein during tracking of objects the continuously determined position and movement of individual pixels is employed.

11. The process according to claim 1, wherein said process is carried out in association with a driver assist system.

12. The process according to claim 1, wherein said process is carried out in association with a robot system.
